(19) United States
(12) Patent Application Publication
(10) Pub. No.: US 2022/0055819 A1
(43) Pub. Date: Feb. 24, 2022

(54) Thermal Insulation Panel, Insulated Shipping Container and Method for Shipping a Temperature Sensitive Product

(71) Applicant: Westrock MWV, LLC, Atlanta, GA (US)

(72) Inventors: Trisha MASSENZO, Richmond, VA (US); Casey P. GREY, Richmond, VA (US); Meredith W. ALLIN, Richmond, VA (US); William STATELMAN, Richmond, VA (US); Nyssa THONGTHAI, Richmond, VA (US); James S. SHORTT, Holly Springs, NC (US); Lester W. BROWN, III, Richmond, VA (US); Martin JUAREZ-ZAMACONA, Summerfield, NC (US); Wensong YANG, Yorktown, VA (US)

(21) Appl. No.: 17/275,045

(22) PCT Filed: Sep. 10, 2019
(86) PCT No.: PCT/US2019/050345

§ 371 Date: Mar. 10, 2021

Related U.S. Application Data
(60) Provisional application No. 62/730,617, filed on Sep. 13, 2018.

(51) Int. Cl. B65D 81/38; B32B 5/02; B32B 3/28; B32B 3/12; B32B 1/02; B65B 5/04; B32B 29/02; B32B 27/12

(52) U.S. Cl. CPC B65D 81/3858; B32B 5/022; B32B 3/28; B32B 3/12; B32B 1/02; B32B 2262/062; B32B 29/02; B32B 27/12; B32B 2307/304; B32B 2307/416; B32B 2439/62; B65B 5/04

(57) ABSTRACT

A thermal insulation panel includes an encasement and an insulative fiber core. The encasement includes a first encasement layer forming a first major surface of the panel and a second encasement layer forming a second major surface of the panel. The insulative fiber core is positioned between the first encasement layer and the second encasement layer.

### REFERENCE TO RELATED APPLICATION

This application claims the benefit of priority under 35 U.S.C. § 119(e) of U.S. provisional application Ser. No. 62/730,617 filed on Sep. 13, 2018, which is hereby incorporated by reference in its entirety.

### FIELD

The present application relates to the field of thermal insulation panels for use with shipping containers for the shipping of temperature sensitive products, particularly for e-commerce applications.

### BACKGROUND

Temperature-sensitive products purchased through e-commerce are often shipped in containers, such as corrugated paperboard containers. To help maintain cool or warm temperatures within a container, it is typical for insulation to be placed within the container. Conventional insulation materials include, for example, expanded polystyrene (EPS).

Accordingly, those skilled in the art continue with research and development in the field of insulation solutions for shipping temperature sensitive products that will keep contents above or below a target temperature for expected ship times.

### SUMMARY

In one embodiment, a thermal insulation panel includes an encasement and an insulative fiber core. The encasement includes a first encasement layer forming a first major surface of the panel and a second encasement layer forming a second major surface of the panel. The insulative fiber core is positioned between the first encasement layer and the second encasement layer.

In another embodiment, an insulated shipping container includes a plurality of walls enclosing an inner compartment and at least one thermal insulation panel in the inner compartment. The thermal insulation panel includes an encasement including a first encasement layer forming a first major surface of the panel and a second encasement layer forming a second major surface of the panel. The thermal insulation panel further includes an insulative fiber core positioned between the first encasement layer and the second encasement layer.

In yet another embodiment, a method for shipping a temperature sensitive product includes positioning at least one thermal insulation panel between at least one temperature sensitive product and a plurality of walls of a shipping container and enclosing the thermal insulation panel and the temperature sensitive product within an inner compartment of the shipping container. The thermal insulation panel includes an encasement including a first encasement layer forming a first major surface of the panel and a second encasement layer forming a second major surface of the panel. The thermal insulation panel further includes an insulative fiber core positioned between the first encasement layer and the second encasement layer.

Other embodiments of the disclosed thermal insulation panel, insulated shipping container, and method for shipping a temperature sensitive product will become apparent from the following detailed description, the accompanying drawings and the appended claims.

### BRIEF DESCRIPTION OF THE DRAWINGS

FIG. 1A is a sectional view of a thermal insulation panel according to an embodiment of the present description, and FIG. 1B illustrates a sectional view of FIG. 1A.

FIG. 2A is a sectional view a variation of the thermal insulation panel of FIGS. 1A and 1B.

FIG. 2B is a sectional view another variation of the thermal insulation panel of FIGS. 1A and 1B.

FIG. 3 is a sectional view of another variation of the thermal insulation panel of FIGS. 1A and 1B.

FIGS. 4A to 4E are perspective views of an exemplary thermal insulation panel including an insulative fiber core formed from fluff pulp inserted into a rigid or flexible encasement.

FIGS. 5A to 5C are perspective views of an exemplary thermal insulation panel including an insulative fiber core formed from fluff pulp inserted between flutes of a corrugated substrate encasement.

FIG. 6 is a perspective view of an exemplary thermal insulation panel according to a further variation.

FIG. 7A is a perspective view of another exemplary thermal insulation panel according to a further variation.

FIG. 7B is a perspective view of a sectional view of another exemplary thermal insulation panel according to a further variation.

FIGS. 8A to 8D are perspective views of an embodiment of an exemplary shipping container according to an embodiment of the present description.

FIG. 9 is a graph showing time to failure of different one inch thick insulation materials with same amount of coolants.

FIG. 10 is a graph showing a comparison of product temperature inside shipper boxes with different one inch thick insulation material with same amount of coolant over time.

FIG. 11 is a graph showing a comparison of product temperature inside shipper boxes with different one inch thick insulation material with coolants over time and product in shipper without insulation and coolants.

FIG. 12 is a flow chart of exemplary manufacturing fluff pulp as insulation material in various arrangements.

FIG. 13 is a graph showing percent difference (%) in r-value of alternative insulations vs. expanded polystyrene (EPS).

FIG. 14 is a graph showing percent difference (%) in r-value of sustainable insulations of the present description vs. expanded polystyrene (EPS).

FIGS. 15 to 17 are graphs showing percent difference (%) in r-value with incremental densities.

FIG. 18 is a graph showing results of compression testing among prototype thermal insulation panels of the present description vs. expanded polystyrene (EPS).

### DETAILED DESCRIPTION

The present description relates to structures and compositions of thermal insulation panels organized to contain insulative fibers to utilize the thermal resistance capabilities of the insulative fibers such as during temperature sensitive storage and/or shipping. More specifically, the present description relates to the incorporation of insulative fibers as an insulative medium in storage, distribution and transportation, for example in the field of e-commerce, as well as arrangements of materials to encase the cellulose fibers or other types of fibers.

In an aspect, the present description relates to the use of cellulose fibers as the insulative fibers. Thermal resistance of cellulose fibers is approximately the same as expanded polystyrene, but cellulose fibers can be arranged in such a way that improves insulative capabilities. Utilizing cellulose fibers as an insulative medium maintains or improves temperature performance over time as well as providing a more sustainable solution for e-commerce shipment of temperature sensitive products compared to expanded polystyrene and compared to cotton/denim containing synthetic polyesters.

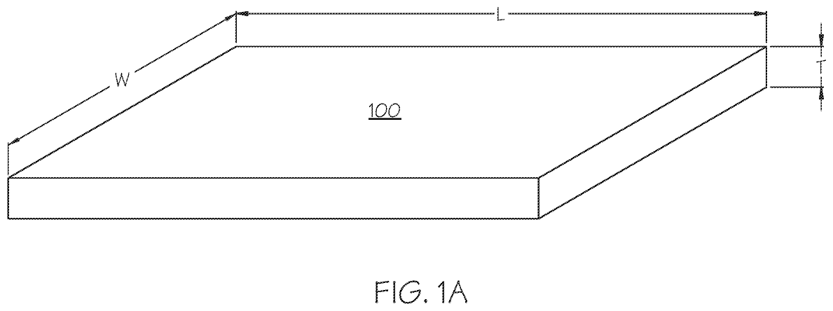

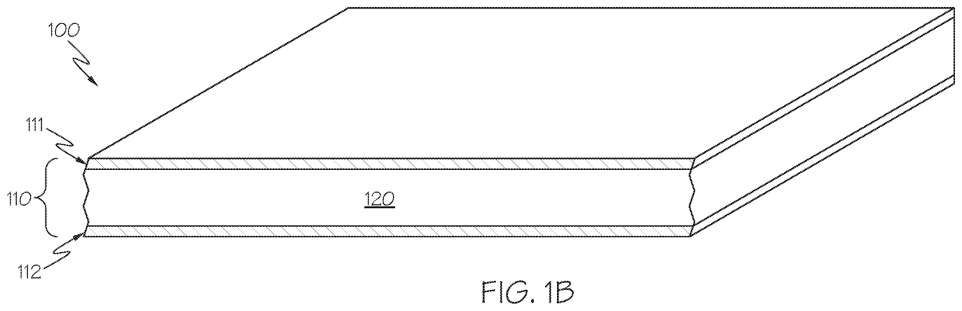

FIG. 1A illustrates a thermal insulation panel according to an embodiment of the present description, and FIG. 1B illustrates a sectional view of FIG. 1A.

As shown in FIG. 1A, the thermal insulation panel 100 has a thickness T that is much less than a length L and width W of the thermal insulation panel 100. Thus, the thermal insulation panel 100 is suitable for use as insulation within a container holding temperature-sensitive products therein.

As shown in FIG. 1B, the thermal insulation panel 100 includes an insulative fiber core 120 and a solid encasement 110 partially or fully encasing the insulative fiber core 120. The encasement 110 has a first encasement layer 111 forming a first major surface of the thermal insulation panel 100 and a second encasement layer 112 forming a second major surface of the thermal insulation panel 100.

The insulative fiber core 120 provides thermal resistance to conduction of heat from the first encasement layer 111 to the second encasement layer 112 across the insulative fiber core 120. Thus, when placed within a shipping container, the thermal insulation panel 100 provides thermal resistance to conduction by buffering the temperature sensitive products from hot, cold or warm environments.

The insulative fiber core 120 may include any insulative fibers materials. In an aspect, the insulative fibers materials of the insulative fiber core 120 are natural fiber materials, such as cellulose-based fiber materials and animal-based fiber materials. In another aspect, the insulative fibers materials of the insulative fiber core 120 are synthetic polymer fiber materials. Cellulose-based fibers may include, for example, wheat fibers, cotton fibers, wood fibers, sugar cane fibers, bamboo fibers, and hemp fibers. Wood fibers may include hardwood fibers and softwood fibers. Animal-based fibers may include, for example, wool, silk, cashmere, and down feathers. Synthetic polymer fibers may include, for example, polyamide fibers, polyester fibers, and polyolefin fibers.

In an aspect, the insulative fibers materials (e.g., cellulose fibers) of the insulative fiber core 120 may be virgin insulative fibers. In yet another aspect, the insulative fibers materials of the insulative fiber core 120 may be recycled insulative fibers.

The insulative fiber materials (e.g., cellulose fibers) of the insulative fiber core 120 may be in the form of a porous sheet of interlinked insulative fibers that are not readily separable. Preferably, the insulative fibers materials of the insulative fiber core 120 are in the form of fiberized insulative fibers, which may be individualized insulative fibers that are readily separable. The fiberized insulative fibers may be agglomerated for subsequent combination with the encasement layer 110.

In a specific preferred example, the fiberized insulative fibers includes fluff pulp.

Insulative fibers materials (e.g., cellulose fibers) suitable for use in the insulative fiber core 120 may be processed to produce a sheet of interlinked insulative fibers, which may then be subjected to a fiberizing process for forming fiberized insulative fibers. In an exemplary and non-limiting fiberizing process, a sheet of interlinked cellulose fibers may be fiberized by, for example, one or more hammermills to provide individualized fibers or agglomerated fibers, which may then be deposited to form a web of the individual fibered cellulose fibers.

In an aspect, the insulative fiber core of the present description may include a super absorbent material, such as a super absorbent polymer. A super absorbent material is a material that can absorb and retain extremely large amounts of a liquid or vapor relative to their own mass. In an aspect, the super absorbent material of the present description absorbs at least 20× its weight, preferably at least 50× its weight, more preferably at least 100× its weight. In an example, the super absorbent material is sodium polyacrylate.

By including the super absorbent material in the insulative fiber core, the super absorbent material provides absorptive capabilities to reduce moisture and humidity. Reducing moisture and humidity can help maintain product quality.

Additionally, moisture and humidity absorption by the insulative fiber materials (e.g., cellulose fibers) of the insulative fiber core can impact thermal resistance of the insulative fiber materials. Accordingly, reducing moisture and humidity by utilization of the super absorbent material can prevent moisture and humidity absorption by the insulative fiber materials, thereby helping to maintain thermal resistance of the thermal insulation panel 100. More specifically, isolating moisture and humidity to the super absorbent material can allow the insulation to have dry air gaps, which resist thermal transfer. Preliminary testing has shown that moisture and humidity can decrease the thermal resistance up to ½ or more compared to r-values at a dry state.

By way of example, the super absorbent material is a super absorbent polymer.

In an exemplary aspect, the super absorbent polymer may have a particle size distribution range of about 15 microns to about 1200 microns. In accordance with the present description, EDANA WSP 220.2 (05) sets forth the standard testing method for determining particle size distribution of the super absorbent polymer of the present description.#

In another exemplary aspect, the super absorbent polymer may have free swelling absorption capacity of up to 400 g/g. In accordance with the present description, EDANA WSP 240.2 (05) sets forth the standard testing method for determining free swelling absorption capacity of the super absorbent polymer of the present description.#

In yet another exemplary aspect, the super absorbent polymer may have absorption against pressure of up to 60 g/g. In accordance with the present description, EDANA WSP 242.2 (05) sets forth the standard testing method for determining absorption against pressure #of the super absorbent polymer of the present description.#

In yet another exemplary aspect, the super absorbent polymer may have permeability of up to 400 Darcie's. In accordance with the present description, EDANA WSP 243.3 (10) sets forth the standard testing method for determining permeability of the super absorbent polymer of the present description.

However, the super absorbent polymer is not limited to the above-identified particle size distribution, free swelling absorption capacity, absorption against pressure/under load, or permeability characteristics.

In an aspect, the super absorbent polymers may include granular, spherical, agglomerated, fibers, in situ forms, or combinations thereof. The super absorbent polymers may include, for example, super absorbent polymers based on acrylic acid and super absorbent polymers based on natural starch.

The encasement layer 110 may include any structure or structures for fully or partially encasing the insulative fiber core 120 between the first encasement layer 111 and the second encasement layer 112. The encasement layer 110 may include a single structure encasing the insulative fiber core 120 to form the first encasement layer 111 and the second encasement layer 112, or the encasement layer 110 may include a first structure forming the first encasement layer 111 and a second structure forming the second encasement layer 112. The encasement layer 110 may include any material or materials. Preferred structures and materials for the encasement layer 110 are discussed in detail below. The encasement layer 110 functions to maintain the shape of the panel and/or provides resistance to convection of air through the insulative fiber core 120.

In an aspect, the insulative fiber core 120 is formed of a porous structure and the encasement layer 110 is formed from a solid structure. The term solid refers to a structure that is either non-porous or much less porous in comparison to the porosity of the insulative fiber core 120. Thus, the encasement layer 110 provides the thermal insulation panel 110 with resistance to convection of air through the insulative fiber core 120.

In an aspect, insulative fiber core is enclosed, partially or fully, by at least one rigid substrate. The term rigid substrate denotes any structure that maintains a consistent shape (e.g., rectangular panel shape) over time. The rigid substrate may have a plurality of sides (e.g., two sides, three sides, four sides, five sides, six sides) to maintain a desired panel shape. In an example, the rigid substrate may be a paperboard substrate. In another example, the insulative fiber core may be sandwiched by two opposing substrates, such as opposing corrugated substrates. By enclosing the insulative fiber core in a rigid substrate, the thermal insulation panel maintains a consistent shape beneficial for insulating against conduction through an external wall of a shipping container or internal partitions of a shipping container and for improving load bearing capabilities of the thermal insulation panel.

In an aspect, insulative fiber core is enclosed by a flexible substrate. The term flexible substrate denotes any structure that readily deforms and may or may not return to a consistent shape. Exemplary flexible substrates include paper (e.g., kraft) or flexible plastic (e.g., nylon). By enclosing the insulative fiber core with a flexible substrate, the thermal insulation panel retains flexibility to bend around the internal components (e.g., wrap around temperature sensitive products being shipped) of the shipping container. This ability to bend around (e.g., wrap around) the internal components of the shipping container can decrease airflow to the temperature sensitive product and thereby lower the chances of heat transfer through convection. A feature of the flexible substrate of the encasement layer 110 include that the thermal insulation panel comprising the insulative fiber core enclosed by the flexible substrate can further function as padding for shock absorption.

In another aspect, the flexible substrate may be a semi-rigid substrate. The term semi-rigid substrate denotes a structure that ready deforms in one direction but resists deformation in an opposite direction. For example, a semi-rigid substrate includes a corrugated panel having one facing sheet with the other face of the corrugated medium being open.

In an aspect, the flexible substrate of the encasement layer 110 includes paper (e.g., kraft paper produced from chemical pulp produced in the kraft process). For example, the first encasement layer 111 may be formed from a first layer of paper (e.g., kraft) and/or the second encasement layer 112 may be formed from a second layer of paper (e.g., kraft). Alternatively, the insulative fiber core 120 may be encased within a single layer of paper (e.g., bagged by kraft) such that the single layer of paper (e.g., kraft) forms the first encasement layer 111 and the second encasement layer 112. By encasing the cellulose fiber 120 partially or fully with paper (e.g., kraft), the paper (e.g., kraft) encasement layer 110 advantageously provides substantial resistance to convection while maintaining flexibility to bend around the internal components and while providing improved environmental sustainability.

In an aspect, the flexible substrate of the encasement layer 110 includes flexible plastic (e.g., nylon). For example, the first encasement layer 111 may be formed from a first layer of flexible plastic and/or the second encasement layer 112 may be formed from a second layer of flexible plastic. Alternatively, the insulative fiber core 120 may be encased within a single layer of flexible plastic (e.g., wrapped in flexible plastic) such that the single layer of flexible plastic forms the first encasement layer 111 and the second encasement layer 112. By encasing the cellulose fiber 120 partially or fully with flexible plastic, the flexible plastic encasement layer 110 advantageously seals the thermal insulation panel from convection while maintaining flexibility to bend around the internal components.

In an aspect, the first encasement layer 111 is formed from a rigid substrate, and the second encasement layer 112 is formed from a flexible substrate. Thus, the rigid substrate aids to maintain a desired panel shape beneficial for insulating against conduction through an external wall of a shipping container or internal partition of a shipping container and for improving load bearing capabilities of the thermal insulation panel, while the flexible substrate retains flexibility to bend around the internal components (e.g., temperature sensitive products being shipped) of the shipping container.

In an aspect, the encasement layer 110 may include an impermeable material. For example, the encasement layer 110 may be formed from the impermeable material (e.g., flexible plastic such as nylon). In another example, the encasement layer 110 may be formed from another material and the impermeable material (e.g., flexible plastic such as nylon) may be formed on a surface of another material, such as an outer surface of the thermal insulation panel closest to an external environment.

The impermeable material may be water impermeable or both water and water vapor impermeable. Thus, a benefit to the impermeable layer (e.g., plastic layer) is to prevent water from entering into an internal compartment of a shipping container. Another benefit to the impermeable layer (e.g., plastic layer) is to prevent airflow (convection).

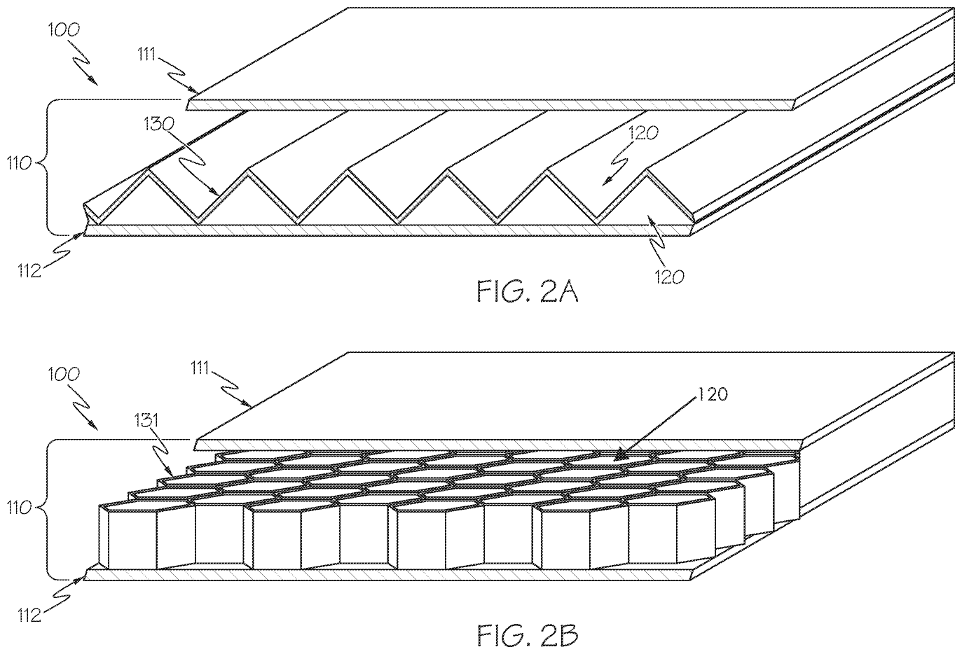

FIG. 2A illustrates a variation of the thermal insulation panel of FIGS. 1A and 1B. As shown in FIG. 2A, the thermal insulation panel 100 differs from FIGS. 1A and 1B by further inclusion of a corrugation flutes 130 in the insulative fiber core 120. For example, the cellulose fiber material of the insulative fiber core 120 may be introduced (e.g., blown) between the corrugation flutes 130 of a corrugated substrate and vacuum sealed, or folded or glue or otherwise sealed so cellulose fiber material (e.g., fluff pulp) does not escape. In a variation shown in FIG. 2B, the thermal insulation panel 100 may alternatively have a honeycomb structure 131 in the insulative fiber core 120, wherein the insulative fiber material (e.g. cellulose fibers) of the insulative fiber core 120 is introduced in the cavities of the honeycomb structure 131.

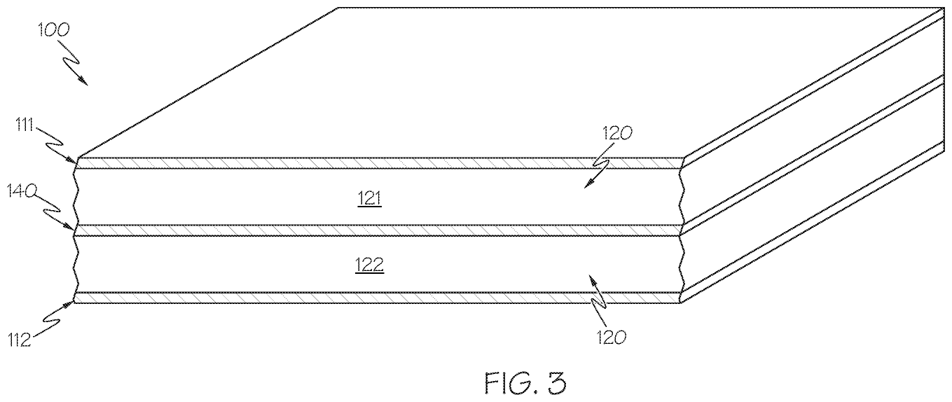

FIG. 3 illustrates another variation of the thermal insulation panel of FIGS. 1A and 1B. As shown in FIG. 3, the thermal insulation panel 100 differs from FIGS. 1A and 1B by further inclusion of at least one intermediate layer 140 between a first portion 121 and a second portion 122 of the insulative fiber core 120. The intermediate layer 140 may include any solid substrate, which may be a rigid or flexible substrate. By inclusion of the intermediate layer 140, air becomes trapped and prevented from moving between the first portion 121 and the second portion 122 of the insulative fiber core 120 by the solid substrate of the intermediate layer 140.

In an aspect, the first encasement layer 111, the second encasement layer 112, and the intermediate layer 140 include a flexible substrate, such as paper (e.g., kraft). By including paper in the first encasement layer 111, the second encasement layer 112, and the intermediate layer 140, the paper layers advantageously provides substantial resistance to convection while maintaining flexibility to bend around the internal components and while providing improved environmental sustainability.

In another aspect, the first encasement layer 111 and the second encasement layer 112 include a flexible substrate, such as paper (e.g., kraft), while the intermediate layer 140 includes a rigid substrate. Thus, the rigid substrate of the intermediate layer 140 aids to maintain a desired panel shape beneficial for insulating against conduction through an external wall or internal partition of a shipping container and improving load bearing capabilities of the thermal insulation panel, while the flexible substrate of the first encasement layer 111 and the second encasement layer 112 retains flexibility to bend around the internal components (e.g., temperature sensitive products being shipped) of the shipping container.

In yet another aspect, the first portion 121 of the insulative fiber core 120 may include a super absorbent material while the second portion 122 may not include a super absorbent material. Thus, the super absorbent material may be positioned where it is most needed, such as a surface of the thermal insulation panel facing a temperature sensitive product.

In yet another aspect, the thermal insulation panel 100 may comprise additional encasement layers alternating with additional intermediate layers.

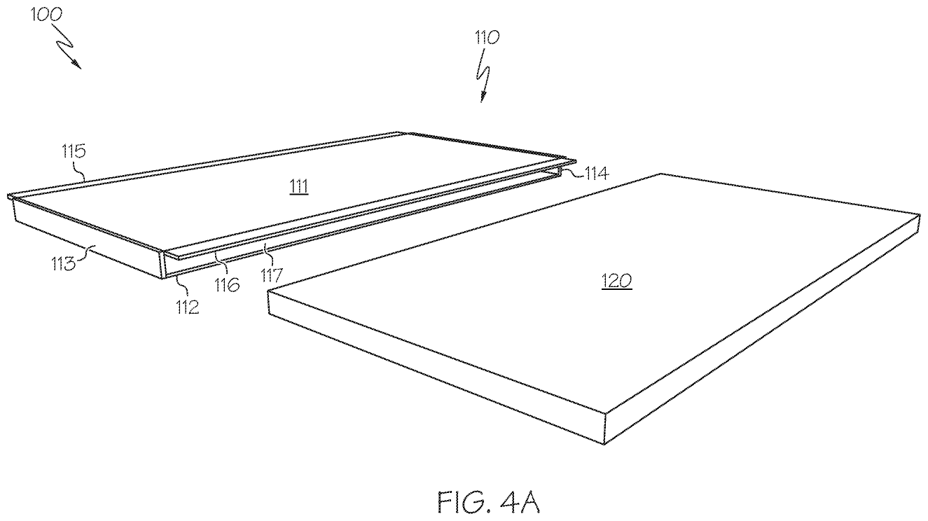

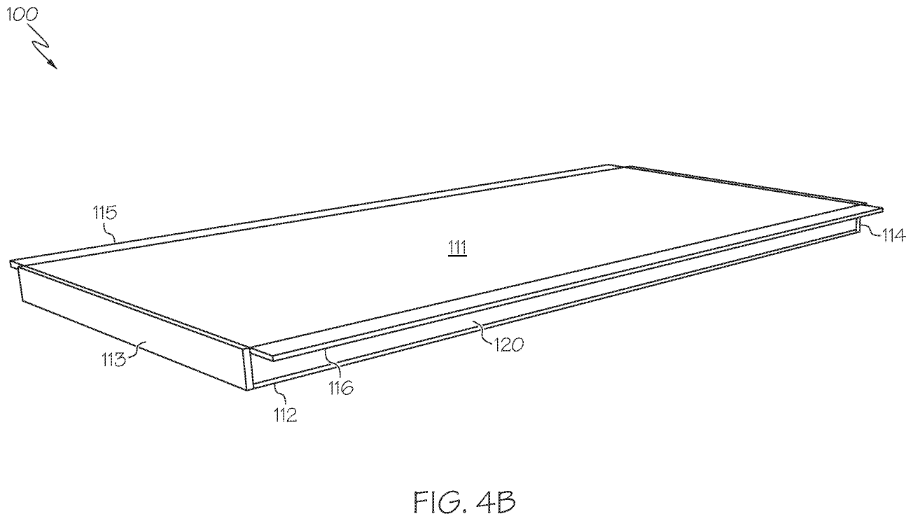

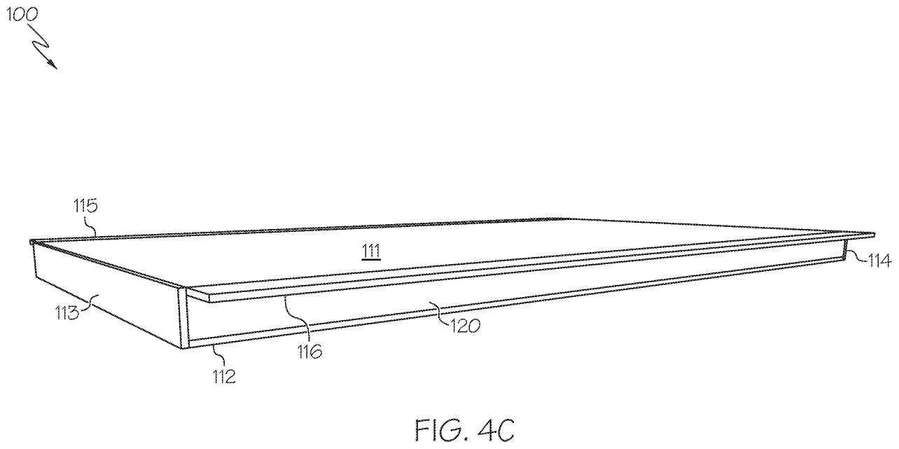

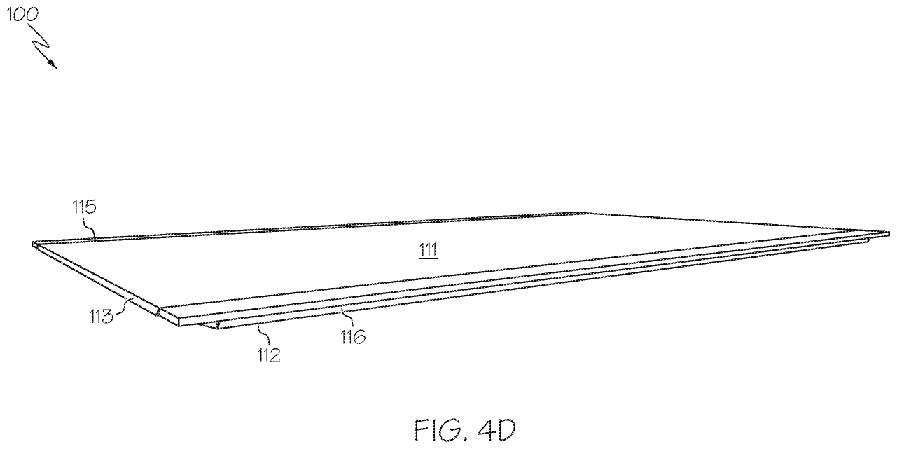

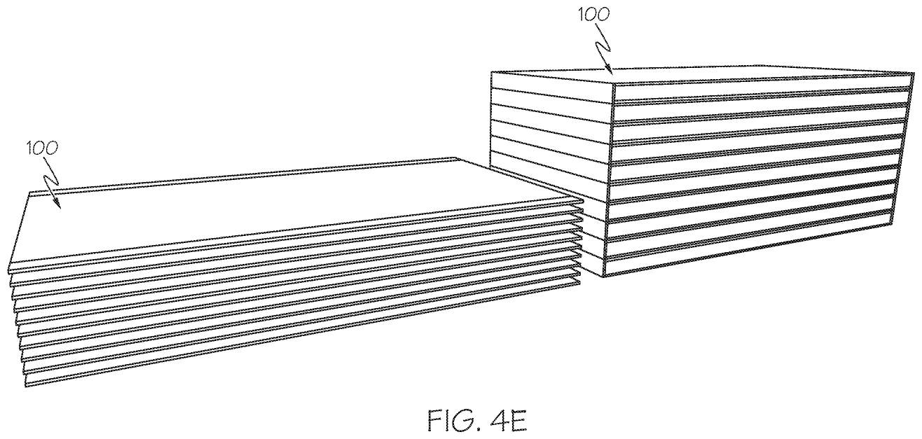

FIGS. 4A to 4E illustrate an exemplary thermal insulation panel 100 including an insulative fiber core 120 formed from fluff pulp inserted into an encasement 110. The encasement 110 may be, for example, a rigid encasement (e.g., paperboard) or flexible encasement (e.g., paper).

As shown in FIG. 4A, the encasement 110 comprises a first encasement layer 111 forming a first major surface of the encasement 110 and a second encasement layer 112 opposite the first encasement layer 111 forming a second major surface of the encasement 110. FIG. 4A further illustrates a third encasement layer 113 and opposing fourth encasement layer 114 extending between the first encasement layer 111 and second encasement layer 112. FIG. 4A further illustrates a fifth encasement layer 115 and opposing sixth encasement layer 116, in which at least the sixth encasement layer 116 are capable of opening to reveal an internal cavity 117 for receiving the insulative fiber core 120.

FIG. 4B shows a filled thermal insulation panel 100 of FIG. 4A in a condition in which the insulative fiber core 120 has been inserted to the internal cavity 117 of the encasement 110.

FIG. 4C shows a variation in which the thermal insulation panel 100 of FIG. 4B is configured such that the thermal insulation panel 100 is capable of standing upright. As shown in FIG. 4C, the fifth encasement layer 115 is either not openable or bonded to a closed position to maintain a position of the fifth encasement layer 115 relative to the surrounding first encasement layer 111, second encasement layer 112, third encasement layer 113, and fourth encasement layer 114.

FIG. 4D shows a variation in which the thermal insulation panel 100 of FIG. 4C is configured such that the thermal insulation panel 100 is capable of lying flat for ease of transportation. This configuration improves the efficiency at which these thermal insulation panels can be transported. As shown in FIG. 4D, the fifth encasement layer 115 is capable of opening. As such, the thermal insulation panel 100 may be flattened by compressing the insulative fiber core 120 between the first encasement layer 111 and the second encasement layer 112.

FIG. 4E shows an exemplary comparison of the upright thermal insulation panels 100 of FIG. 4C with the flattened thermal insulation panels 100 of FIG. 4D.

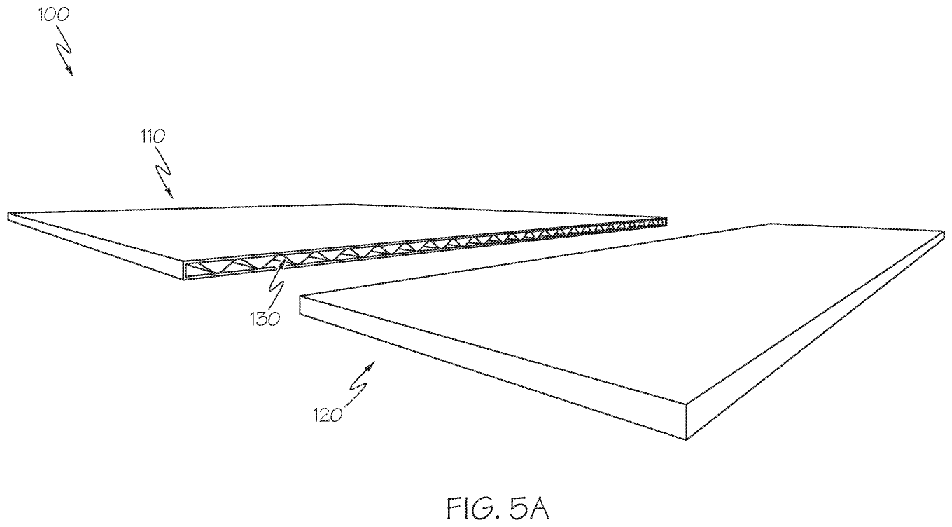

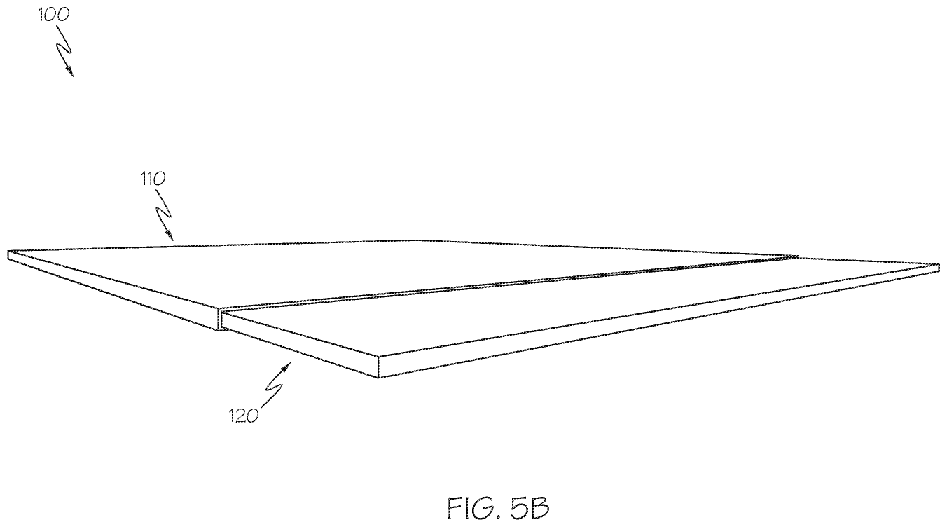

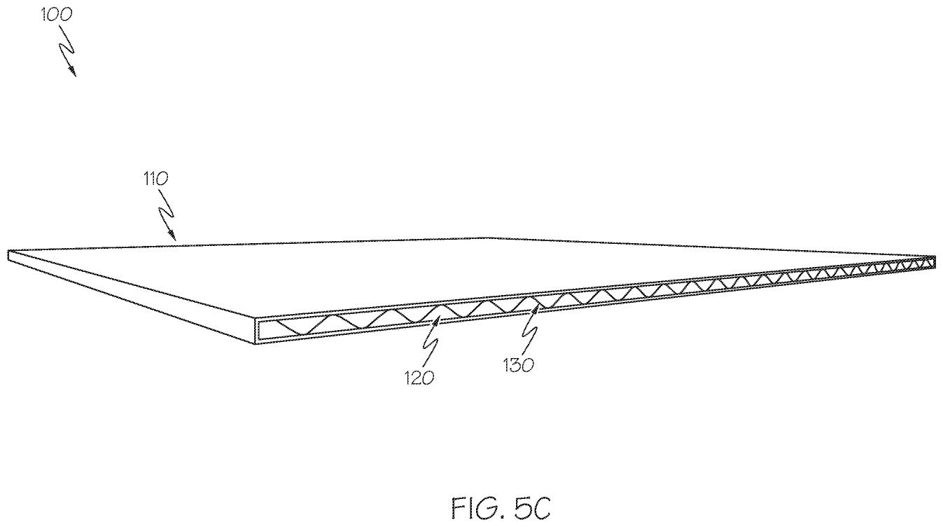

FIGS. 5A to 5C illustrate an exemplary thermal insulation panel 100 including an insulative fiber core 120 formed from fluff pulp inserted between flutes of a corrugated substrate encasement 110.

As shown in FIG. 5A, the encasement 110 comprises corrugation flutes 130 in an internal cavity therein, in which recesses between the corrugation flutes 130 are capable of receiving the insulative fiber core 120. FIG. 5B shows a thermal insulation panel 100 of FIG. 5A in a condition in which the insulative fiber core 120 has been partially inserted to the internal cavity of the encasement 110. FIG. 5C shows a thermal insulation panel 100 of FIG. 5A in a condition in which the insulative fiber core 120 has been fully inserted to the internal cavity of the encasement 110.

As an alternative to FIGS. 5A to 5C, the cellulose fiber material of the insulative fiber core 120 may be introduced (e.g., blown) between the corrugation flutes 130 (or alternatively within a honeycomb structure 131) and vacuum sealed, or folded or glue or otherwise sealed so cellulose fiber material (e.g., fluff pulp) does not escape.

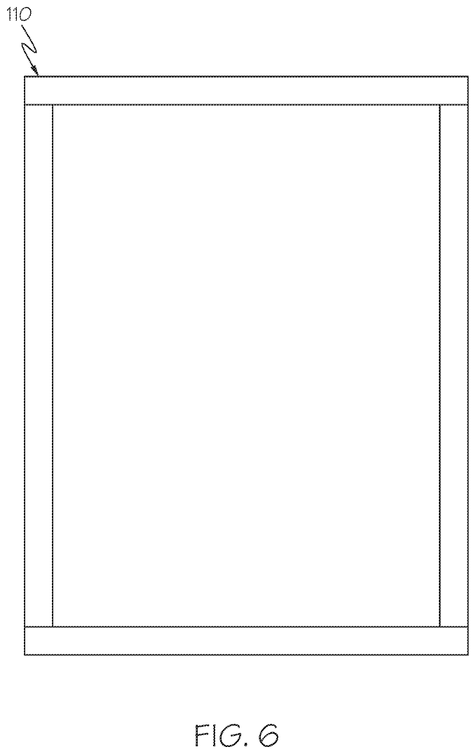

FIG. 6 illustrates an exemplary thermal insulation panel 100 according to a further variation. As shown in FIG. 6, fiberized cellulose fibers in rigid or flexible panels are arranged in a B-flute corrugated box. For example, rigid panels may be paperboard or corrugated panels. Flexible panels may be, for example, flexible plastic (e.g., nylon), uncoated kraft panels, non-woven materials.

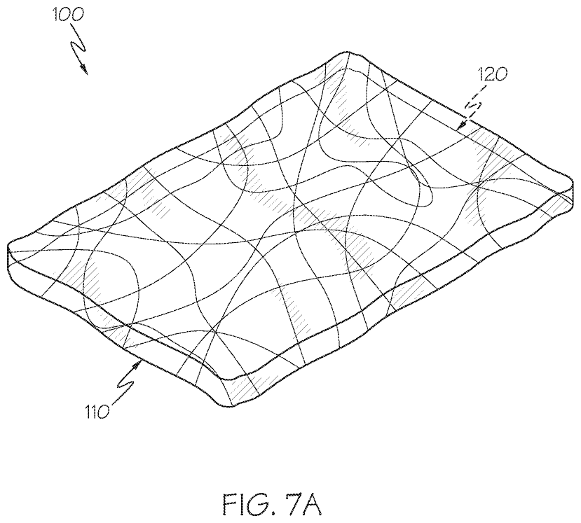

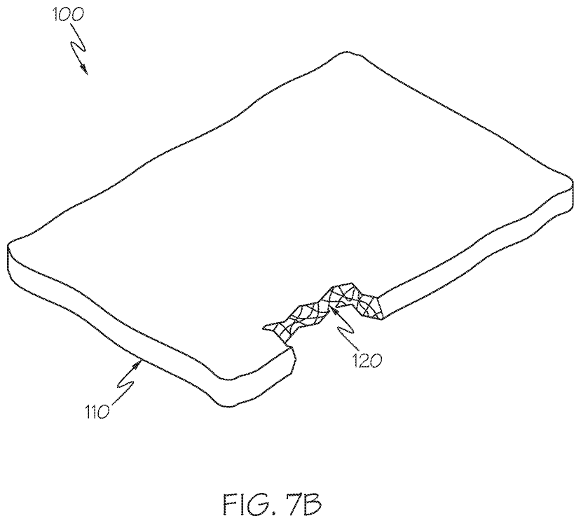

FIGS. 7A and 7B relate to exemplary thermal insulation panels 100 according to further variations in which fiberized cellulose fibers 120 are enclosed in a flexible encasement. As shown in FIG. 7A, fiberized cellulose fibers 120 are vacuum sealed in an encasement 110 suitable to hold a vacuum for vacuum sealing to form a thermal insulation panel 100. For example, the encasement 110 may be formed from flexible plastic (e.g., nylon). As shown in FIG. 7B, fiberized cellulose fibers 120 are bagged in encasement 110 formed from a flexible substrate such as paper (e.g., kraft) to form a thermal insulation panel 100.

The thermal insulation panels 100 of the present description may include one or more additional layers not previously illustrated or described. In an example, the thermal insulation panels 100 according to any one more variations described above may further include a reflective layer to provide resistance from heat transfer via radiation. In another example, the thermal insulation panels 100 according to any one more variations described above may further include a sealed component to restrict airflow (convection) to the cellulose insulated core 120. In yet another example, the thermal insulation panels 100 according to any one more variations described above may further include one or more thermal coatings to provide additional insulative protection.

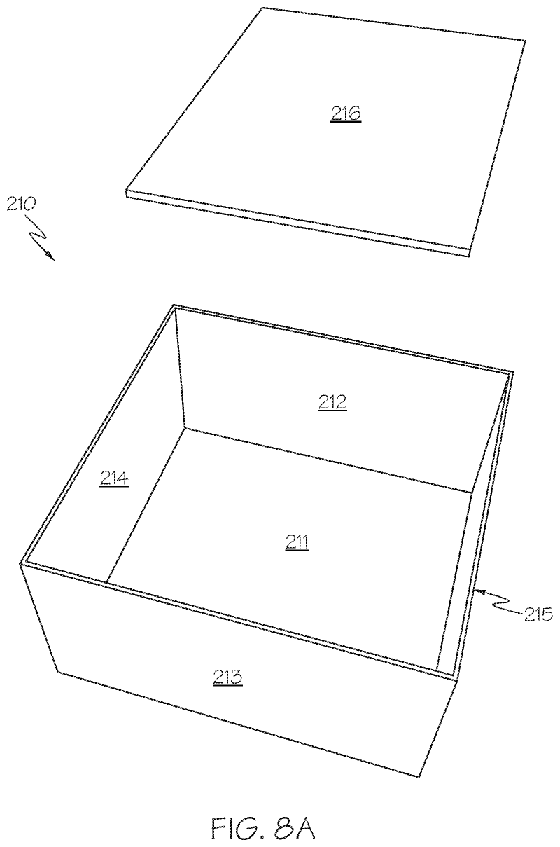

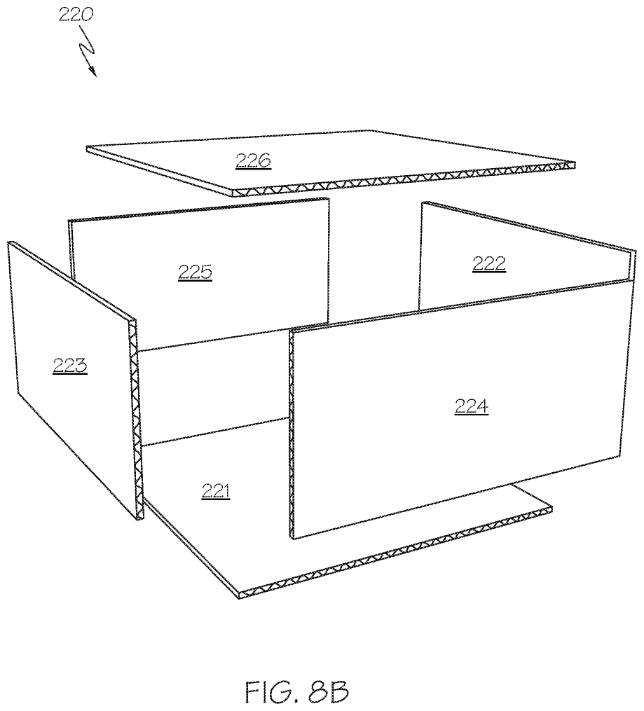

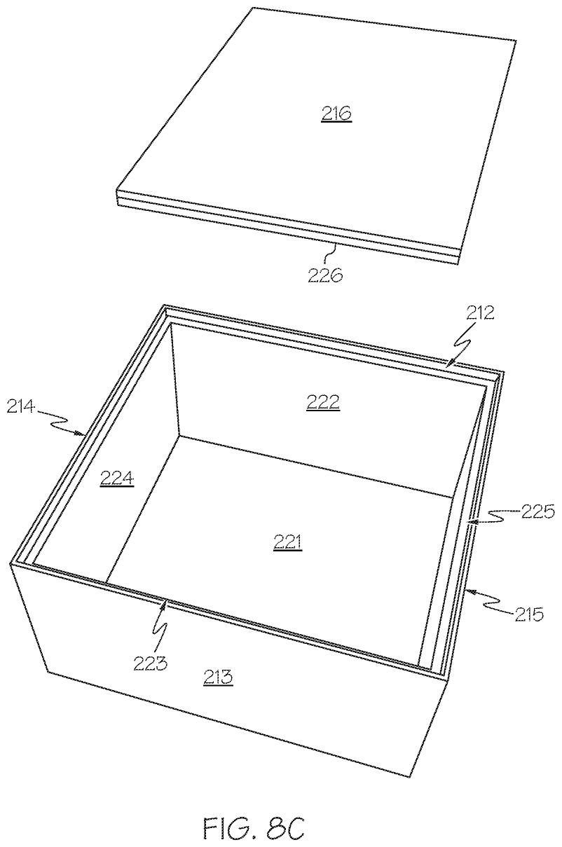

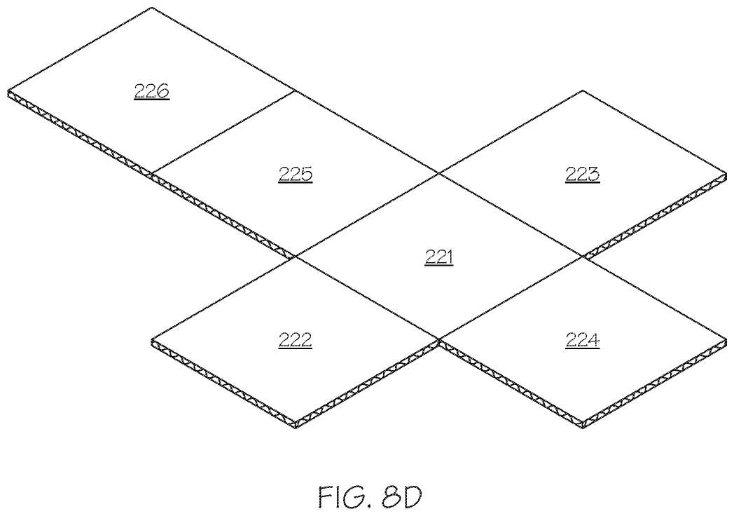

FIGS. 8A to 8C illustrate an embodiment of an exemplary shipping container of the present description. As shown in FIG. 8A, the insulated shipping container 200 includes shipping container 210 having a base 211, sidewalls 212, 213, 214, and 215 extending upwardly from the base 211, and lid 216 for covering an internal cavity of the shipping container. It will be understood that the present description is not limited by the specific details of the illustrated shipping container. The thermal insulation panels of the present description are applicable to any shipping container.

As shown in FIG. 8B, the insulated shipping container further includes one or more thermal insulation panels 220, which may include bottom panel 221, side panels 222, 223, 224, and 225 and top panel 226. The thermal insulation panels 220 of the insulated shipping container 200 may take the form of any one or more thermal insulation panels 100 as previously hereinafter described. FIG. 8C shows an exemplary positioning of panels 220 in shipping container 210 to form the insulated shipping container 200 of the present description.

Thus, as shown in FIGS. 8A to 8C, the thermal insulation panels 220 may be provided to surround an internal cavity of the shipping container 210. However, it is not necessary to fully insulate the shipping container 210.

Additionally, a feature of the present description is that a plurality of thermal insulation panels 220 may be stacked together at a single side of the container to provide an increase in thermal resistance. Thus, a number of thermal insulation panels in the stack of thermal insulation panels may be selected depending on the sensitivity of the temperature sensitive product.

As illustrated in FIG. 8D, a variation provides that a plurality of thermal insulation panels may be interconnected (e.g., one assembly of a plurality of thermal insulation panels unfolds to fit box easily). As shown in FIG. 8D, panel 221 is connected at one side to each of panels 222, 223, 224, and 225, and panel 226 is connected at one side to panel 225, such that the assembly of panels is foldable from a T-shape to fit within the shipping container 210 and surround the internal cavity of the shipping container. Alternatively, the assembly of panels may be interconnected to form a standalone enclosure around a temperature sensitive product without being placed within a separate shipping container 210.

In another variation one or more thermal insulation panels may form an internal partition between adjacent compartments within the shipping container, such as when a temperature sensitive product and non-temperature sensitive product are positioned within the adjacent compartments of the shipping container.

A purpose of this present description is to develop insulation for an e-commerce packaging solution for an initial key market capable of shipping temperature sensitive products that will keep contents below or above a target temperature for expected ship times, maintain product integrity, and improve sustainability.

The present description may be used for shipment and storage of temperature sensitive products and construction of other temporary thermal structures.

This present description provides a sustainable solution that performs the same or better than current solutions in temperature management during shipping. Additionally, the present description is not limited to improved thermal resistance. Rather, it is believed that the present description may lead to an improvement in strength of packaging while maintaining the thermal and structural integrity of internal components.

An advantage of the thermal insulation panel of the present description includes providing a sustainable alternative to expanded polystyrene.

Another advantage of the thermal insulation panel of the present description includes providing an effective insulator from heat transfer.

Yet another advantage of the thermal insulation panel of the present description includes providing flexibility and bends around a temperature sensitive product being shipped.

Yet another advantage of the thermal insulation panel of the present description includes thermal insulating panels capable of providing padding for shock absorption.

Yet another advantage of the thermal insulation panel of the present description includes providing rigidity for strength applications.

Yet another advantage of the thermal insulation panel of the present description includes providing adjustable insulation level to meet thermal insulation needs by adding/subtracting thermal insulation panels, by adding/subtracting fiber density within the encasement, or by adding/subtracting amounts of super absorbent materials.

Yet another advantage of the thermal insulation panel of the present description includes providing capability for decreasing the amount of cellulose fibers contained in a multi-layer structure without drastically lowering the thermal resistance, since the air is still trapped within the multi-layer structure.

Yet another advantage of the thermal insulation panel of the present description includes sustainability. Various embodiments of the present description may be more or less sustainable. For example, a highly sustainable embodiment includes an encasement formed from kraft and an insulative fiber core having cellulose fibers. In another example, a highly sustainable embodiment includes an encasement formed from kraft and an insulative fiber core having cellulose fibers and a super absorbent polymer based on natural starch.

The following graphs relate to results of testing that evidence one or more advantages or features of the present description.

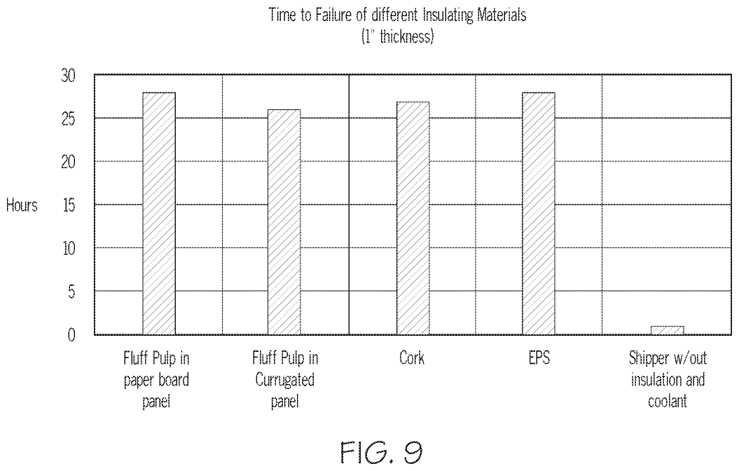

FIG. 9 is a graph showing time to failure of different one inch thick insulation materials with same amount of coolants.

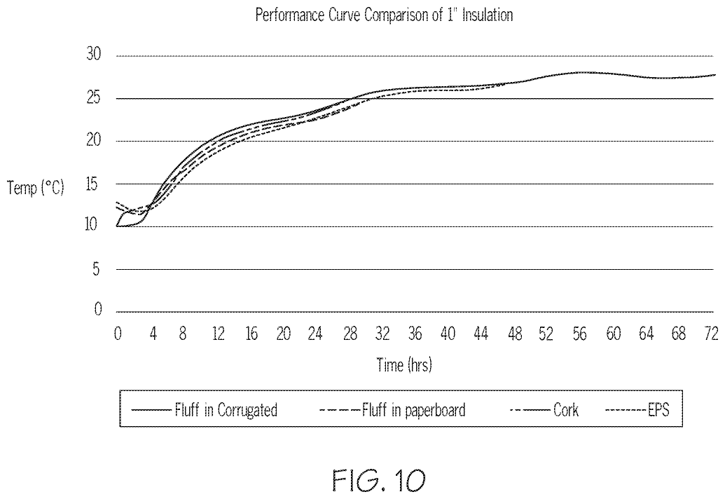

FIG. 10 is a graph showing a comparison of product temperature inside shipper boxes with different one inch thick insulation material with same amount of coolant over time.

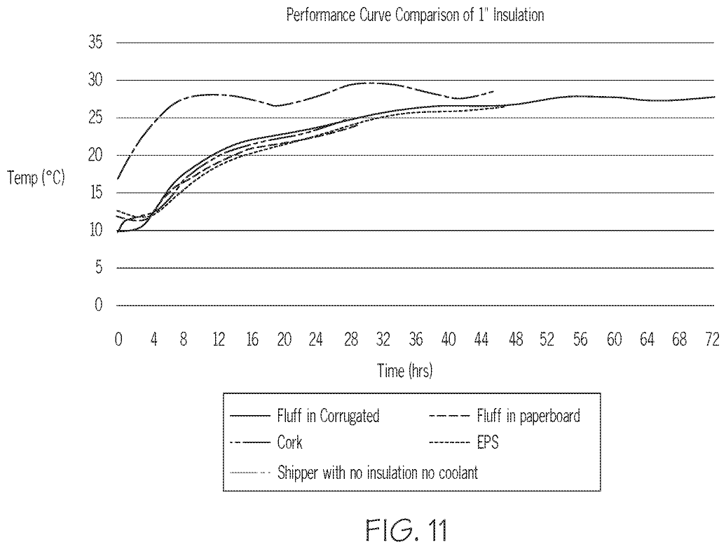

FIG. 11 is a graph showing a comparison of product temperature inside shipper boxes with different one inch thick insulation material with coolants over time and product in shipper without insulation and coolants.

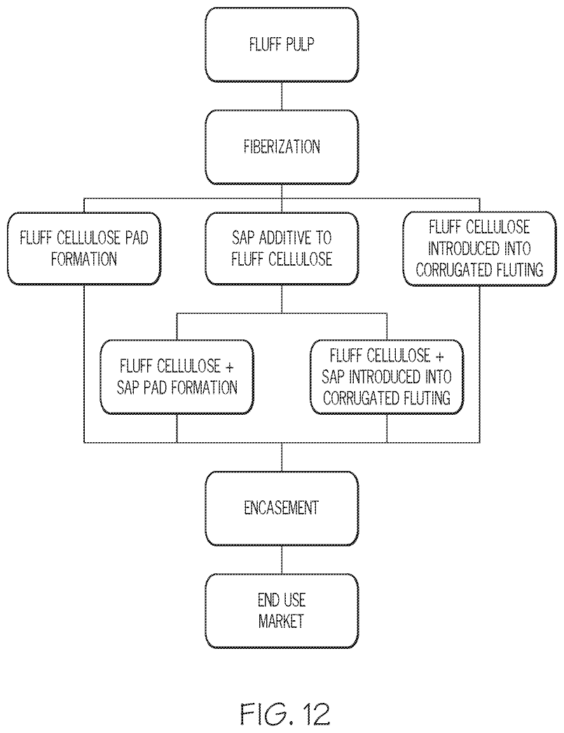

FIG. 12 is a flow chart of exemplary manufacturing fluff pulp as insulation material in various arrangements.

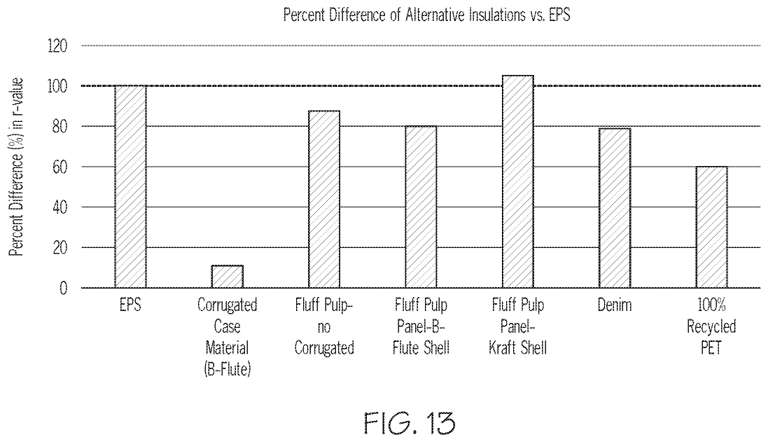

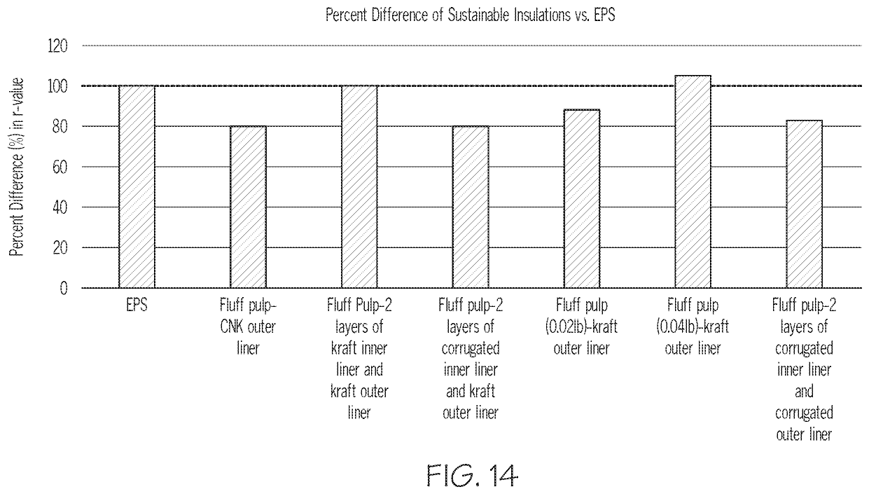

FIG. 13 is a graph showing percent difference (%) in r-value of alternative insulations vs. expanded polystyrene (EPS). FIG. 14 is a graph showing percent difference (%) in r-value of sustainable insulations of the present description vs. expanded polystyrene (EPS). Expanded polystyrene (EPS) and loose-fill cellulose match very well to published data for industrial insulation. Further modification to the structure can act to diminish insulative capacity via compression (e.g., fluff pulp panel in B-flute shell) if the volume of fibers is not reduced to achieve optimal density. The kraft shell results show that improvement beyond EPS is possible with the right combination of shell material, structure, and fluff pulp density.

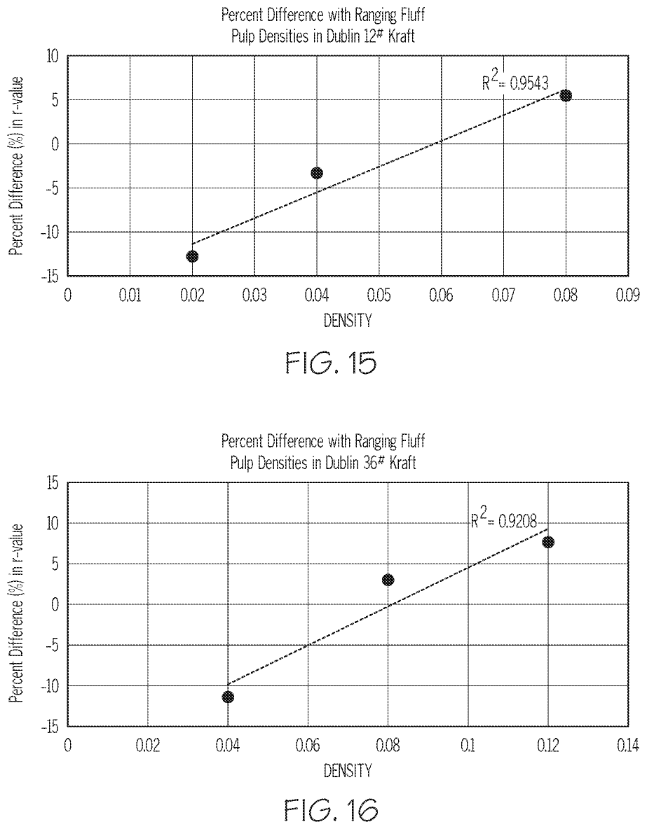

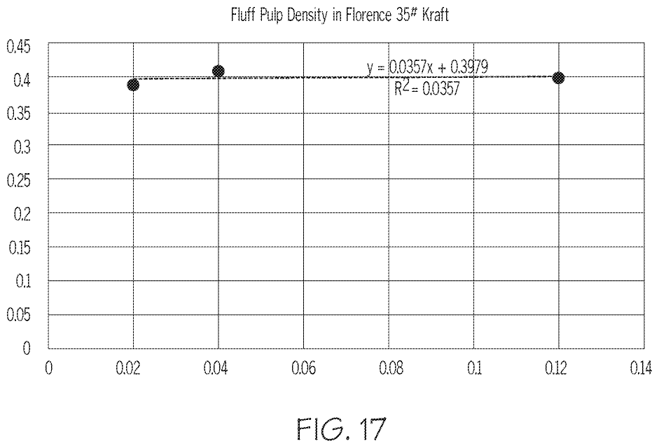

FIGS. 15 to 17 are graphs showing percent difference (%) in r-value with incremental densities.

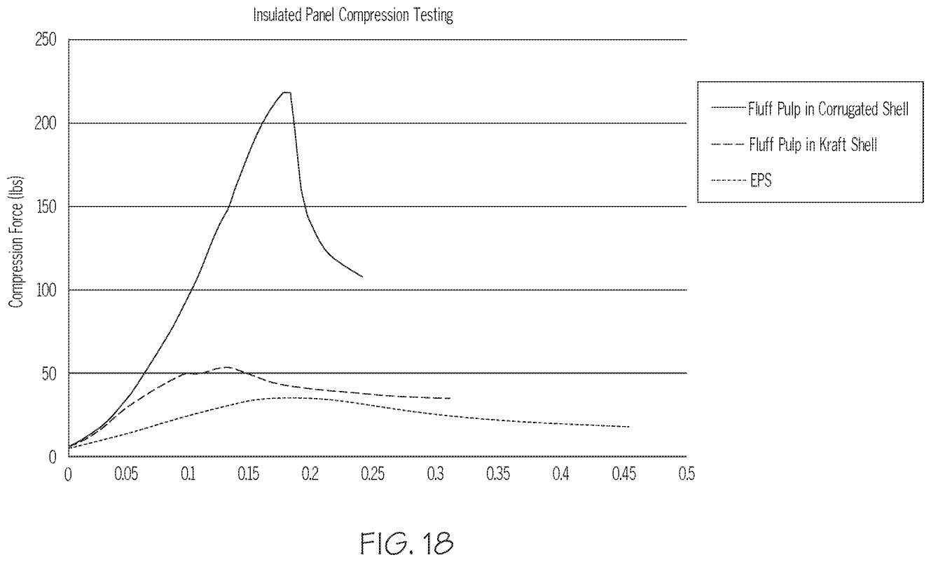

FIG. 18 is a graph results of compression testing among prototype thermal insulation panels of the present description.

According to the results, thermal resistance testing was conducted to trial the different arrangements and compare to insulations used for e-commerce. According to the results, r-value for different fluff pulp arrangements was found to be similar to EPS. According to the results, it was found that the best tested arrangement was a single layer of fluff pulp inside kraft encasement.

Although various embodiments of the disclosed thermal insulation panel, insulated shipping container, and method for shipping a temperature sensitive product have been shown and described, modifications may occur to those skilled in the art upon reading the specification. The present application includes such modifications and is limited only by the scope of the claims.

1. A thermal insulation panel comprising:
an encasement comprising a first encasement layer forming a first major surface of the panel and a second encasement layer forming a second major surface of the panel; and
an insulative fiber core positioned between the first encasement layer and the second encasement layer.

2. The thermal insulation panel of claim 1 wherein the insulative fiber core is in the form of a sheet of interlinked insulative fibers.

3. The thermal insulation panel of claim 1 wherein the insulative fiber core is in the form of fiberized insulative fibers.

4.-29. (canceled)

30. The thermal insulation panel of claim 1 wherein the encasement comprises a rigid substrate enclosing the insulative fiber core.

31. The thermal insulation panel of claim 1 wherein the encasement comprises a semi-rigid substrate enclosing the insulative fiber core.

32. The thermal insulation panel of claim 1 wherein the encasement comprises a pair of corrugated substrates sandwiching the insulative fiber core.

33. The thermal insulation panel of claim 1 wherein the encasement comprises a corrugated substrate having flutes or a honeycomb structure, and wherein the insulative fiber core is positioned between the flutes or within the honeycomb structure of the corrugated substrate.

34. The thermal insulation panel of claim 1 further comprising a reflective layer outside of one of the first encasement layer and the second encasement layer.

35. The thermal insulation panel of claim 1 further comprising an intermediate layer separating a first portion and a second portion of the insulative fiber core.

36. The thermal insulation panel of claim 35 wherein the intermediate layer comprises a rigid substrate.

37. The thermal insulation panel of claim 35 wherein the intermediate layer comprises a flexible substrate.

38. The thermal insulation panel of claim 1 wherein the insulative fiber core comprises a single layer of fluff pulp inside the encasement, wherein the encasement is a flexible encasement.

39.-44. (canceled)

45. The thermal insulation panel of claim 43 wherein the plurality of interconnected thermal insulation panels comprises a plurality of interconnected walls formed from interconnected thermal insulation panels.

46. The thermal insulation panel of claim 43 wherein the plurality of interconnected thermal insulation panels form a standalone enclosure around a temperature sensitive product without being placed within a separate shipping container.

47. An insulated shipping container comprising:
a plurality of walls enclosing an inner compartment; and
at least one thermal insulation panel in the inner compartment, the thermal insulation panel comprising:
an encasement comprising a first encasement layer forming a first major surface of the panel and a second encasement layer forming a second major surface of the panel; and
an insulative fiber core positioned between the first encasement layer and the second encasement layer.

48. The shipping container of claim 47 wherein the at least one thermal insulation panel comprises a stack of thermal insulation panels.

49. The shipping container of claim 47 wherein the at least one thermal insulation panel comprises a plurality of interconnected thermal insulation panels.

50. A method for shipping a temperature sensitive product, the method comprising:
positioning at least one thermal insulation panel between at least one temperature sensitive product and a plurality of walls of a shipping container, the thermal insulation panel comprising:
an encasement comprising a first encasement layer forming a first major surface of the panel and a second encasement layer forming a second major surface of the panel; and
an insulative fiber core positioned between the first encasement layer and the second encasement layer; and
enclosing the thermal insulation panel and the temperature sensitive product within an inner compartment of the shipping container.

51. The method of claim 50 wherein the encasement comprises a flexible substrate, and wherein positioning the thermal insulation panel comprises bending the flexible substrate around the temperature sensitive product.

52. The method of claim 50 wherein thermal insulation panel forms an internal partition between adjacent compartments within the shipping container.
